(19) United States
(12) Patent Application Publication
(10) Pub. No.: US 2014/0059236 A1
(43) Pub. Date: Feb. 27, 2014

(54) Process for Peer-To-Peer Download of Software Installer

(71) Applicants: Yuan-Chang Lo, Austin, TX (US); Clint H. O'Connor, Austin, TX (US); Gary D. Huber, Austin, TX (US); Michael Haze, Round Rock, TX (US); William Nix, Austin, TX (US)

(72) Inventors: Yuan-Chang Lo, Austin, TX (US); Clint H. O'Connor, Austin, TX (US); Gary D. Huber, Austin, TX (US); Michael Haze, Round Rock, TX (US); William Nix, Austin, TX (US)

(21) Appl. No.: 13/595,214

(22) Filed: Aug. 27, 2012

(51) Int. Cl. G06F 15/16

(52) U.S. Cl. 709/227; 709/245

(57) ABSTRACT

A system, method, and computer-readable medium are disclosed for performing automated, peer-to-peer migrations of entitled digital assets. A first identifier corresponding to a source system, and a first set of entitlement data corresponding to a set of digital assets installed on the source system, are processed to generate a first set of entitlements entitling the source system to use the set of digital assets. The first identifier is then cross-referenced to a second identifier corresponding to a target system. A migration request and the second identifier are received from the target system, which are then processed to initiate the migration of the digital assets from the source system to the target system. The second identifier and the first set of entitlement data are subsequently processed to generate a second set of digital asset entitlements entitling the target system to use the set of digital assets.

### BACKGROUND OF THE INVENTION

1. Field of the Invention

The present invention relates to the management of information handling systems. More specifically, embodiments of the invention provide a system, method, and computer-readable medium for performing automated, peer-to-peer downloads of entitled digital assets.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, it has become common for manufacturers to offer purchasers the ability to order a system custom-configured to their specification. These custom-configured systems, which are often ordered on-line, allow the purchaser to select the OS of their choice along with a selection of software and other digital assets to meet their individual needs. In some cases, the manufacturer may preinstall the OS and the selected digital assets on the system prior to delivery. In addition, the system may be further personalized (e.g., desktop themes and colors, etc.) as a service to the customer. Such customizations and personalizations may be limited only by the customer's patience and willingness to define or describe their ideal system.

However, it is not uncommon for the manufacturer to only install a subset of the digital assets a given system is entitled to use. As an example, the user of a system may be given the option of using various digital assets (e.g., stock photo libraries), or not, at their discretion. In this example, the desired digital asset may be downloaded from the system manufacturer or a digital asset provider to the target system, typically over an Internet connection. However, such transfers may be time consuming due to constrained download speeds.

Medium-sized business and enterprises typically address this issue by using an on-premise distribution server to act as a cache for digital asset distribution within their company network. However, this type of facility is not generally available for home and small business environments. Furthermore, this approach usually requires a designated system to act as a distribution point as well as an administrator that is technically astute, which are resources that are not always available for these environments. Moreover, the distribution server may not have a resident copy of a requested digital asset. As a result, it is typically first downloaded from its source location to the distribution server, cached, and then downloaded in turn to the requestor's system.

In consumer environments, peer-to-peer transfer has been used extensively for downloading large files, such as using BitTorrent to transfer Linux ISO images. While effective, these methods may entail security and legal issues, are sometimes blocked by firewalls, and may not always be reliable. Furthermore, the desired digital asset may be sourced from multiple peer machines, which may not be sufficiently available to provide a complete copy of the desired digital asset at a given point in time. Moreover, network latency and bandwidth constraints associated with these approaches may increase download times. In view of the foregoing, there is a need for a more effective approach for peer-to-peer downloads of entitled digital assets.

### SUMMARY OF THE INVENTION

A system, method, and computer-readable medium are disclosed for performing automated, peer-to-peer downloads of entitled digital assets. In various embodiments, a digital asset entitlement system is implemented to manage the entitlement of peer systems to use a predetermined digital asset. In these and other embodiments, an identifier associated with a first system and entitlement data corresponding to a digital asset are processed to generate a set of digital asset entitlements. In turn, the digital asset entitlements are processed to generate an address list comprising a first set of address data corresponding to the location of the digital asset on a second system. The address list is then provided to the first system.

The first system then uses the first set of address data to establish a peer-to-peer (P2P) communications session with the second system, during which the first system receives the digital asset. Once the digital asset is received, the first system provides a second set of address data corresponding to the location of the digital asset on the first system. The second set of address data is then appended to the address list. In various embodiments, the second set of address data may comprise a Uniform Resource Locator (URL), a host name, an Internet Protocol (IP) address, or a Media Access Control (MAC) address associated with the first system.

In one embodiment, the address list comprises a third set of address data corresponding to the location of the digital asset on a third system configured to provide the digital asset to the first system. In this embodiment, the first system uses the third set of address data to establish a P2P communications session with the third system if the second system is unavailable. Once the P2P communications session is established, the first system receives the digital asset from the third system. In various embodiments, the first system is subsequently configured to provide the digital asset to a fourth system that is entitled to use it.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of the performance of peer-to-peer digital asset download operations;

FIGS. 3a-b are a simplified block diagram of a unique system identifier that remains the same when one of its associated system component identifiers has been changed;

FIGS. 4a-b are a simplified block diagram of a unique system identifier that is changed when one of its associated system component identifiers has been changed;

FIG. 5 is a simplified block diagram of an encrypted unique system identifier generated from a set of system component identifiers;

FIG. 6 is a simplified block diagram of a unique system identifier decrypted from an encrypted unique system identifier;

FIGS. 7a-b are a generalized flow chart of the performance of digital asset entitlement operations; and

FIGS. 8a-b are a generalized flow chart of the performance of peer-to-peer digital asset download operations.

### DETAILED DESCRIPTION

A system, method, and computer-readable medium are disclosed for performing automated, peer-to-peer migrations of entitled digital assets. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

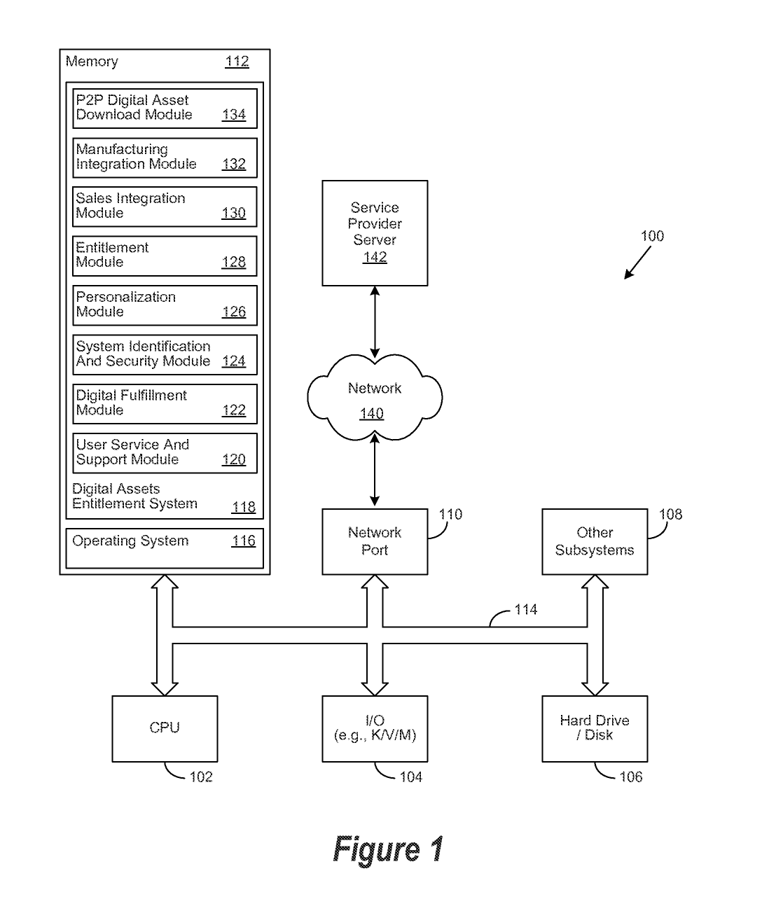

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a digital asset entitlement system 118. In these and other embodiments, the digital asset entitlement system 118 may likewise comprise a user service and support module 120, a digital fulfillment module 122, a system identification and security module 124, a personalization module 126, an entitlement module 128, a sales integration module 130, a manufacturing integration module 132, and a digital asset download module 134. In one embodiment, the information handling system 100 is able to download the digital asset entitlement system 118 from the service provider server 142. In another embodiment, the digitals asset entitlement system 118 is provided as a service from the service provider server 142.

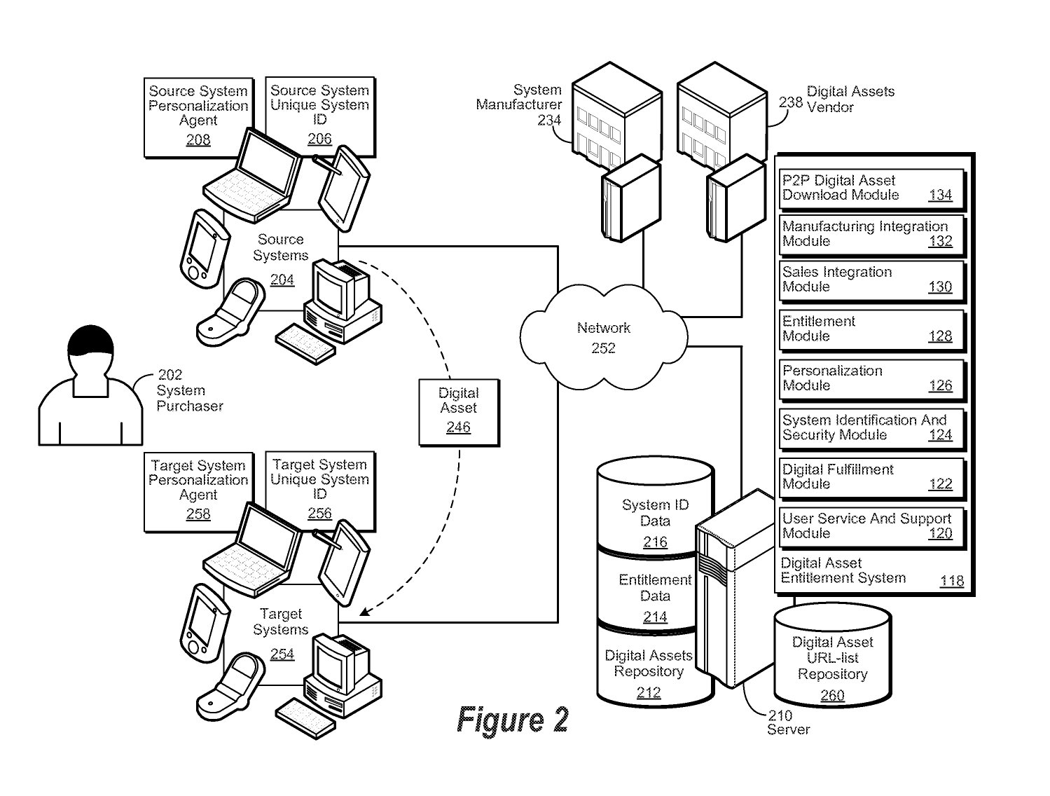

FIG. 2 is a simplified block diagram of the performance of peer-to-peer (P2P) digital asset download operations. In various embodiments, a digital asset entitlement system 118 is implemented for managing the entitlement of a source 204 system or a target 254 system to process a digital asset 246. In these and other embodiments, the digital asset entitlement system 118 may be implemented on one or more servers 210, which are connected to a network 252. In various embodiments, the network 252 may comprise a public network, such as the Internet, a physical private network, a virtual private network (VPN), or any combination thereof.

As shown in FIG. 2, the digital asset entitlement system 118 comprises a user service and support module 120, a digital fulfillment module 122, and a system identification and security module 124. The digital asset entitlement system 118 likewise comprises a personalization module 126, an entitlement module 128, a sales integration module 130, a manufacturing integration module 132, and a P2P digital asset download module 134. Likewise, the digital asset entitlement system 118 is able to access a digital assets data repository 212, an entitlement data repository 214, system identifier (ID) data repository 216, and a digital asset URL-list repository 260, each of which may be implemented on one or more servers 210 connected to a network 252.

In this and other embodiments, the digital asset URL-list repository 260 comprises a plurality of URL-lists. As used herein, a URL-list broadly refers to a prioritized list of Uniform Resource Locators (URLs) familiar to those of skill in the art. In various embodiments, each URL in the URL-list references a location where a given digital asset resides and can be downloaded. In these and other embodiments, a predetermined digital asset 246 is downloaded by the digital asset entitlement system 118 to a source system 204 the first time is purchased by a customer. In one embodiment, the digital asset 246 is downloaded from the digital assets repository 212. In another embodiment, the digital asset 246 is downloaded from a digital assets vendor 238. In yet another embodiment, the digital asset 246 is downloaded from a system manufacturer 234.

Once the digital asset 246 is downloaded to the source system 204, an associated URL-list is created. The URL-list is then populated with two URLs. The first URL is the location of the digital asset 246 installed on the source system 204. The second URL is the original location (e.g., the digital assets repository 212, the digital assets vendor 238, the system manufacturer 234, etc.) of the digital asset 246. In various embodiments, a unique identifier is used in place of the second URL. Thereafter, a new URL for the predetermined digital asset 246 is added to the URL-list each time it is added to a new peer system (e.g., source system(s) 204). In various embodiments, the last URL in the URL-list is the original location of the digital asset 246.

As used herein, a digital asset 246 refers to any digital asset such as a software application, a deliverable or performable service, music, video, software activation key, personalization instructions, files, etc. that are digitally deliverable either wholly or partially. As likewise used herein, a digital assets entitlement refers to the association of a predetermined digital asset 246 with either a source 204 or target 254 system. In various embodiments, an entitlement record contains digital assets entitlement data (e.g., license information, etc.) that allows the digital asset 246 to be respectively processed by the source 204 or target 254 system, which are likewise respectively identified by a corresponding unique source 206 or target 256 system identifier. In these and other embodiments, the entitlement record is processed by the entitlement module 128 and stored in the entitlement data repository 214. As used herein, a source 204 or target 254 system may comprise a personal computer, a laptop computer, or a tablet computer operable to establish an on-line session with the digital asset entitlement system 118 over a connection to network 252. The source 204 target 254 system may also comprise a personal digital assistant (PDA), a mobile telephone, or any other suitable device operable to store a unique source 204 or target 254 system ID, respectively perform digital asset entitlement operations with a source 208 or target 258 system personalization agent, and operable to establish a connection with network 252.

In various embodiments, digital assets entitlement and system personalization operations are performed by a user, such as a system purchaser 202, in on-line environment. As an example, an on-line environment may comprise a system manufacturer 234 or digital assets vendor 238 that respectively accepts on-line orders for systems or digital assets over a connection to network 252.

If these and other embodiments, the system purchaser 202 decides whether to purchase a custom-configured or pre-configured target 254 system. If the target 254 system is to be pre-configured, then it is selected for on-line purchase by the system purchaser 202 and its unique target system 256 identifier is determined. In one embodiment, the unique target 256 system identifier is stored in the BIOS of the pre-configured target 254 system. However, if the target 254 system is to be custom-configured, then it is custom-configured on-line by the system purchaser 202. Once manufactured by the system manufacturer 234, a unique target 256 system identifier is generated as described in greater detail herein.

In various embodiments, the manufacturing integration module 132 coordinates the custom configuration of the target 254 system with the system manufacturer 234. Likewise, the system identification and security module 124 coordinates the generation of the unique target 256 system identifier and its storage in the repository of system identifier data 216. The system purchaser 202 then selects one or more digital assets 246 for on-line purchase, followed by selecting personalization options for the pre-configured or custom-configured system. In various embodiments, the personalization module 126 coordinates the selection of personalization options with the system manufacturer 234 or digital assets vendor 238. As used herein, a system personalization option refers to any feature, capability, or function that may be applied to a target system. As an example, a personal computer desktop wallpaper or user interface options (e.g., a “classic” interface) are personalization options.

A purchase transaction for the custom-configured or pre-configured system target 254 system and any associated digital assets 246 and personalization options is then completed. In various embodiments, the processing of the purchase transaction is performed by the sales integration module 230. In these and other embodiments, the financial proceeds of the purchase transaction may be settled between multiple parties. For example, a system manufacturer 234 may receive a portion of the purchase transaction corresponding to the cost of the target 254 system. One or more digital assets vendors 238 may likewise receive a proportionate share of the purchase transaction corresponding to the digital assets 246 they respectively provide.

Digital asset entitlement operations, as described in greater detail herein, are then performed by the digital asset entitlement system 118 to bind the digital assets 246, the personalization options, and their respective digital assets entitlement data to the unique target 256 system identifier of the target 254 system. The resulting digital asset entitlements, including data associated with the digital assets (e.g., installation files, etc.) is then stored in the repository of entitlement data 214. The custom-configured or pre-configured target 254 system is then delivered to the system purchaser 202. In various embodiments, the entitlement module 128 generates, and then processes, the digital assets entitlement data and the user service and support module 120 coordinates the delivery of the target 254 system to the system purchaser 202.

Standard operating system (OS) out-of-the-box-experience (OOBE) or hypervisor boot operations are performed on the target 254 system, followed by activating the target 258 system personalization agent. In various embodiments, the target 258 system personalization agent has a unique identifier that is associated with one or more unique system component identifiers. In one embodiment, the unique identifier of the target 258 system personalization agent is uniquely associated with the current unique target 256 system identifier associated with the target 254 system. In another embodiment, a portion of the target 258 system personalization agent is delivered to the target 258 system in an encrypted form and is then decrypted prior to being loaded on the target 254 system. In this embodiment, the primary system identifier (e.g., service tag number, serial number, etc.), is used as a decryption key to decrypt the target 258 system personalization agent.

In various other embodiments, secondary system identifiers are stored on the target 254 system (e.g., in the BIOS, in Flash memory, on a hard disk, etc.) as well as in the digital asset entitlement system 118. In these and other embodiments, the digital asset entitlement system 118 uses the secondary system identifiers to encrypt a portion of the target 258 system personalization agent before it is loaded onto the target 254 system. Once activated, the unencrypted portion of the target 258 system personalization agent uses the secondary system identifiers stored on the target 254 system to decrypt the encrypted portion of the target 258 system personalization agent. In one embodiment, the secondary system identifiers are likewise encrypted and are first decrypted before they are used to decrypt the encrypted portion of the target 258 system personalization agent. In another embodiment, the secondary system identifiers are stored in a Trusted Platform Module (TPM). Skilled practitioners of the art will recognize that many such embodiments are possible and the foregoing is not intended to limit the spirit, scope, or intent of the invention.

The target 258 system personalization agent then queries the target 254 system for its unique target 256 system identifier. In various embodiments, the unique system identifier associated with the target system is stored in the target 254 system's BIOS, flash memory, a hard disk, or other memory device. However, if hypervisor (e.g., virtual machine monitor, or VMM) first boot operations are performed on the target 254 system instead, then a service OS comprising an embedded virtual machine monitor (VMM) and an embedded target 258 system personalization agent are loaded on the target 254 system.

The target 258 system personalization agent then automatically establishes a connection with the digital asset entitlement system 118 and uses the target 254 system's unique target 256 system identifier to authenticate it to the digital asset entitlement system 118. The unique target 256 system identifier is then used by the target 258 system personalization agent to determine its entitled digital assets, which may include an OS and personalization options. A determination is then made whether to download one or more entitled digital assets 246 from a peer system, such as a source system 204. If so, the digital assets to be downloaded are selected, followed by the receipt of a URL-list containing the URLs of the selected digital assets 246. In one embodiment, the system 258 personalization agent requests the URL-list from the digital asset entitlement system 118, which then supplies it to the target 258 personalization system from the digital asset URL-list repository 260.

A URL for each of the selected digital assets to be downloaded is then likewise selected from the URL-list, followed by a determination being made whether the peer system (e.g., a source 204 system) corresponding to the selected URL is available. If not, then a different URL is selected from the URL-list and the process is completed until an available peer system is identified. If none of the peer systems corresponding to the URLs are available, then the target 258 system personalization agent automatically downloads the target system's 254 entitled digital assets 246 from the digital asset entitlement system 118.

However, if it was determined that a peer system (e.g., source system 204) associated with a selected URL is available, then the selected digital assets 246 are downloaded from the associated peer system. In one embodiment, the peer-to-peer download is performed by the personalization agents 258, 208 respectively installed on the target 254 and source 204 systems. Thereafter, or once the entitled digital assets 246 have been downloaded, the target 258 system personalization agent installs the downloaded digital assets 246 on the target 254 system.

Once the digital assets 246 are installed on the target 254 system, the target 258 system personalization agent provides the target 258 system's associated address information, and the URL of the installed digital asset 246, to the digital asset entitlement system 118. In turn, the digital asset entitlement system 118 adds the address information associated with the target 254 system, including the URL of the installed digital asset 246, to its corresponding URL-list stored in the digital asset URL-list repository 260.

In various embodiments, the address information may comprise the host name of the target 254 system, its IP addresses, and media access control (MAC) addresses. In these and other embodiments, an IP broadcast look-up protocol may be used to obtain the current IP address from the MAC address. In certain embodiments, the transfer of digital assets can be limited to between peer systems (e.g., source 204 and target 254 systems) on the same IP subnet.

In one embodiment, a customer (e.g., system purchaser 202) purchases multiple copies of the digital asset 246 for download and installation on a corresponding number of peer systems (e.g., source 204 and target 254 systems). In this embodiment, the P2P digital asset download module serializes the download of the digital asset 246 such that its first download is to the source 204 system. The URL-list associated with the digital asset 204 is then updated with the URL of the digital asset on the source 204 system. Thereafter, the digital asset 246 is sequentially downloaded from a peer system (e.g., a source 204 system), and once it is installed, its corresponding URL-list is updated with its URL. It will be appreciated that such a serialized, P2P approach to downloading digital assets 246 from multiple peer systems would typically shorten the amount of time required to distribute a predetermined digital asset 246 to multiple peer systems, particularly if the peer systems resided on the same IP subnet.

In various embodiments, install files associated with the digital asset 246 are retained on the source 204 system after the digital asset 246 has been installed. In these and other embodiments, the install files are subsequently downloaded from the source 204 system to facilitate the installation of the digital asset 246 on the target 254 system. It will be appreciated that storage bloat on the source 204 system may be mitigated through the implementation of pruning methods (e.g., quota management, date, staleness, etc.) and distribution methods (e.g., load and storage balancing among peer systems, etc.) familiar to those of skill in the art.

In one embodiment, the digital asset 246 is digitally signed to ensure that its download from its source location (e.g., the digital asset entitlement system 118, the system manufacturer 234, the digital assets vendor 238, or the source 204 system) has not been tampered with. In another embodiment, the URL-list corresponding to a predetermined digital asset 246 is encrypted to protect the privacy of the data it contains. In yet another embodiment, the URL-list comprises a digital hash of various files (e.g., source files, installation files, etc.) associated with the digital asset 246 to ensure their integrity.

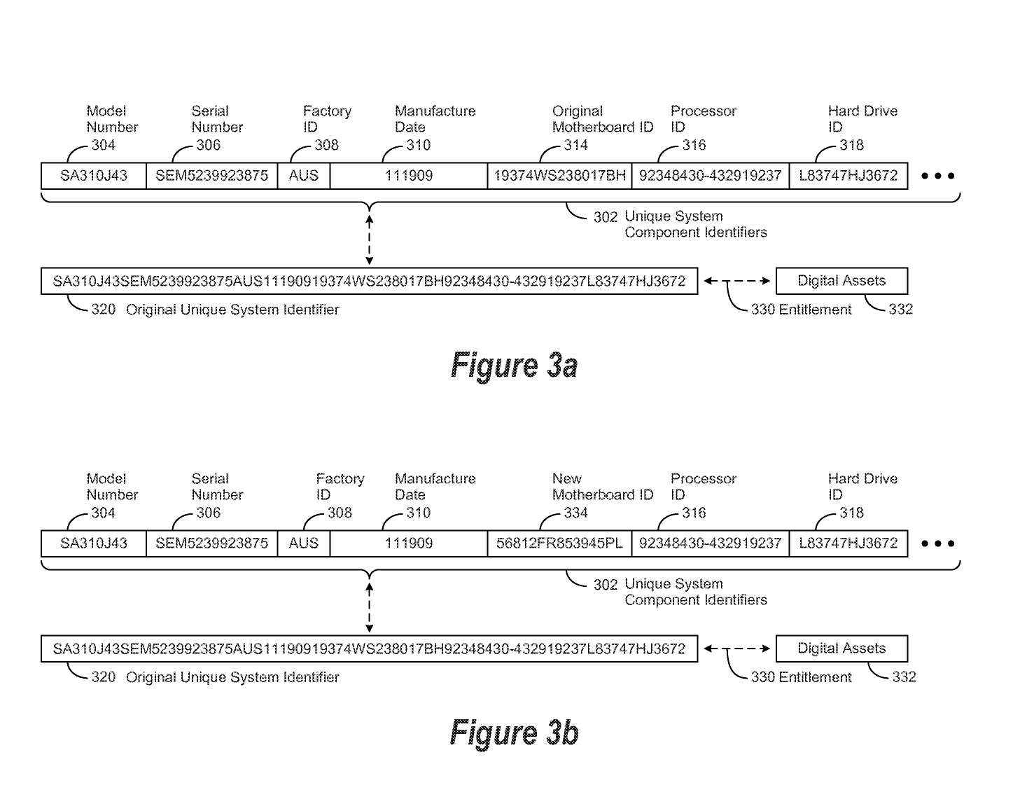

FIGS. 3a-b are a simplified block diagram of a unique system identifier that remains the same when one of its associated system component identifiers has been changed in accordance with an embodiment of the invention. As shown in FIG. 3a, an original unique system identifier 320 is generated from a plurality of unique system component identifiers 302, which correspond to a plurality of system components contained in a target system. As likewise shown in FIG. 3a, the unique system component identifiers 302 comprise a Model Number 304 ‘SA310J43, a Serial Number 306, sometimes referred to as a service tag number or a primary system identifier, ‘SEM5239923875’, a Factory ID 308 ‘AUS’, and a Manufacture Date 310 ‘111909’. The unique system component identifiers 302 likewise comprise an Original Motherboard ID 314 ‘19374WS238017BH’, a Processor ID 316 ‘92348430-432919237’, a Hard Drive ID 318 ‘L83747HJ3672’, etc.

As described in greater detail herein, once generated, the original unique system identifier 320 is associated, such as through a binding operation, with predetermined digital assets 332 to generate a digital assets entitlement 330. As likewise described in greater detail herein, the digital assets entitlement 330 entitles a target system, which is associated with the original unique system identifier 320, to process the digital assets 332. However, it is not uncommon for system components to be replaced due to failure, erratic performance, becoming outmoded, or for other reasons. It will be appreciated that the entitlement 330 between the original unique system identifier 320 and the digital assets 332 may be compromised as a result of such a replacement. For example, as illustrated in FIG. 3b, the Original Motherboard ID 314 ‘19374WS238017BH’ has been replaced with a New Motherboard ID 334 ‘56812FR853945PL’. However, the original unique system identifier 320 remains unchanged.

In various embodiments, extract, transform, and load (ETL) and other database operations are performed to manage the integrity of the relationship between the original unique system identifier 320 and the plurality of unique system component identifiers 302. As an example, the Original Motherboard ID 314 ‘19374WS238017BH’ may remain as a subset of the original unique system identifier 320, even though it may have been deactivated or invalidated as a unique system component identifier 302. However, in these and other embodiments, relational database operations known to those of skill in the art may be applied to maintain the relationship between the original unique system identifier 320, the New Original Motherboard ID 334 ‘56812FR853945PL’, and the unchanged unique system component identifiers 302. Accordingly, the integrity of the entitlement 330 between the original unique system identifier 320 and the digital assets 332 is perpetuated. It will be apparent to skilled practitioners of the art that many such embodiments are possible and the foregoing is not intended to limit the spirit, scope, or intent of the invention.

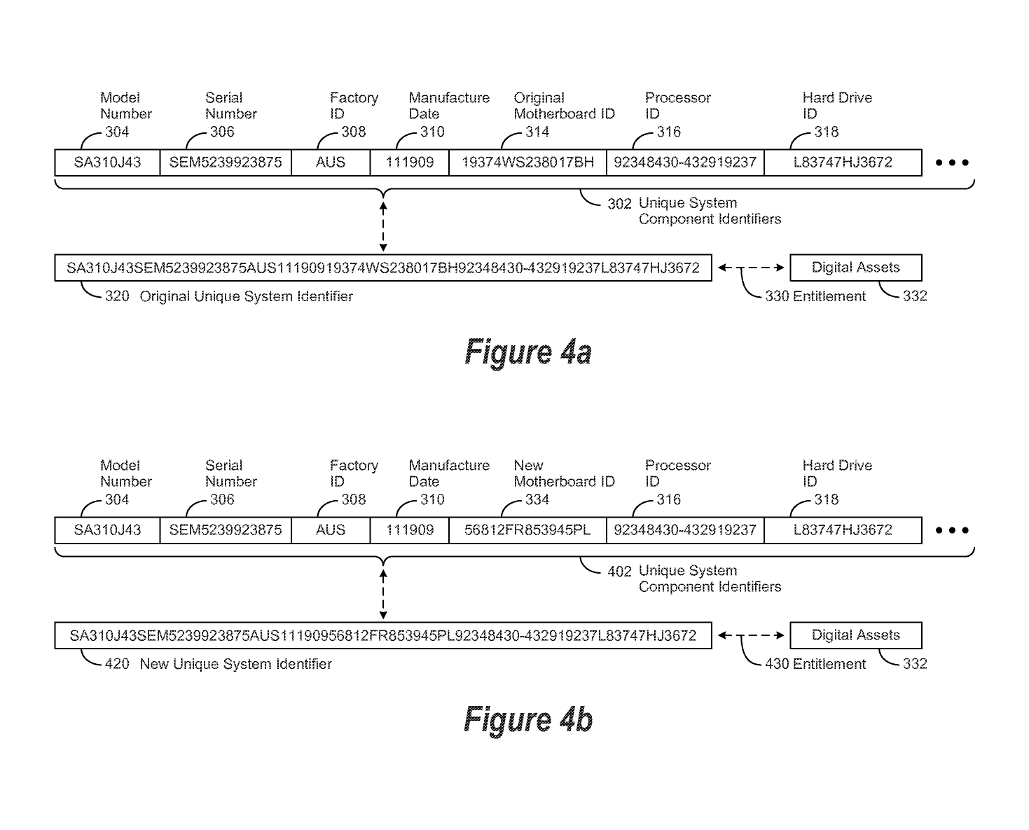

FIGS. 4a-b are a simplified block diagram of a unique system identifier that is changed when one of its associated system component identifiers has been changed in accordance with an embodiment of the invention. As shown in FIG. 4a, an original unique system identifier 320 is generated from a plurality of unique system component identifiers 302, which correspond to a plurality of system components contained in a target system. As likewise shown in FIG. 3a, the unique system component identifiers 302 comprise a Model Number 304 ‘SA310J43, a Serial Number 306, sometimes referred to as a service tag number or a primary system identifier, ‘SEM5239923875’, a Factory ID 308 ‘AUS’, and a Manufacture Date 310 ‘111909’. The unique system component identifiers 302 likewise comprise an Original Motherboard ID 314 ‘19374WS238017BH’, a Processor ID 316 ‘92348430-432919237’, a Hard Drive ID 318 ‘L83747HJ3672’, etc.

As described in greater detail herein, once generated, the original unique system identifier 320 is associated, such as through a binding operation, with predetermined digital assets 332 to generate a digital assets entitlement 330. As likewise described in greater detail herein, the digital assets entitlement 330 entitles a target system, which is associated with the original unique system identifier 320, to process the digital assets 332. However, it is not uncommon for system components to be replaced due to failure, erratic performance, becoming outmoded, or for other reasons. It will be appreciated that the entitlement 330 between the original unique system identifier 320 and the digital assets 332 may be compromised as a result of such a replacement. For example, as illustrated in FIG. 4b, the Original Motherboard ID 314 ‘19374WS238017BH’ has been replaced with a New Motherboard ID 334 ‘56812FR853945PL’. As a result, a new unique system identifier 420 is generated, which is a concatenation of the plurality of unique system component identifiers 402, including the New Original Motherboard ID 334 ‘56812FR853945PL’ as a subset. In certain embodiments, such as when an old system is replaced with an entirely new system, none of the unique system component identifiers 402 associated with the new unique system identifier 420 are the same as the unique system component identifiers 302 associated with the original unique system identifier 320.

In various embodiments, a first set of operations are performed to remove the entitlement 330 between the original unique system identifier 320 and digital assets 332. A second set of operations are then performed to associate the new unique system identifier 420 with the digital assets 332 to generate a new entitlement 430. In these and other embodiments, the original unique system identifier 320 is then invalidated. Accordingly, the integrity of the original entitlement 330 between the original unique system identifier 320 and the digital assets 332 is perpetuated by the new entitlement 430 between the new unique system identifier 420 and the digital assets 332. In certain embodiments, an old system comprising an original unique system identifier 320 is replaced with an entirely new system comprising a new unique system identifier 420. In these and other embodiments, the generation of a new entitlement 430 and the invalidation of the original unique system identifier 320 migrates the entitlement of the digital assets 332 from the old system to the new system. Skilled practitioners of the art will recognize that many such embodiments are possible and the foregoing is not intended to limit the spirit, scope, or intent of the invention.

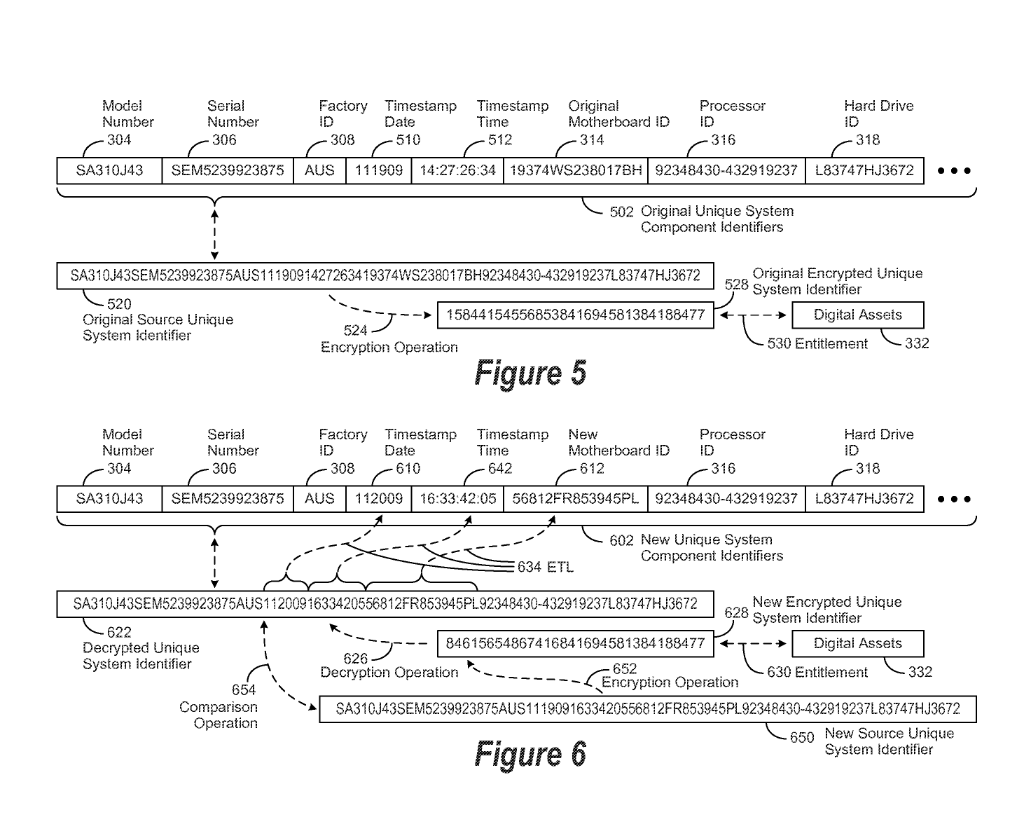

FIG. 5 is a simplified block diagram of an encrypted unique system identifier generated from a set of system component identifiers in accordance with an embodiment of the invention. In this embodiment, a source unique system identifier 520 is generated from a plurality of original unique system component identifiers 502, which correspond to a plurality of system components contained in a target system. As shown in FIG. 5, the original unique system component identifiers 502 comprise a Model Number 304 ‘SA310J43, a Serial Number 306, sometimes referred to as a service tag number or a primary system identifier, ‘SEM5239923875’, a Factory ID 308 ‘AUS’, a Timestamp Date 510 ‘111909’, and a Timestamp Time 512 ‘14:27:26:34’. The original unique system component identifiers 502 likewise comprise an Original Motherboard ID 314 ‘19374WS238017BH’, a Processor ID 316 ‘92348430-432919237’, a Hard Drive ID 318 ‘L83747HJ3672’, etc.

An encryption operation 524 is then performed on the source unique system identifier 520 to generate an original encrypted unique system identifier 528. In various embodiments, the encryption operation may comprise the use of a private key, a public key, key pairs, or any combination of keys and cryptographic operations such as implemented in a public key infrastructure (PKI). As an example, the original encrypted unique system identifier 528 may be generated using a private key associated with the manufacturer of the system and a public key associated with the system itself. In one embodiment, the Timestamp Date 510 ‘111909’ and the Timestamp Time 512 ‘14:27:26:34’ are likewise used to generate the encrypted unique system identifier 528. Skilled practitioners of the art will be familiar with such cryptographic operations and recognize that many such embodiments are possible and that the foregoing is not intended to limit the spirit, scope, or intent of the invention.

As described in greater detail herein, once generated, the original encrypted unique system identifier 528 is associated, such as through a binding operation, with predetermined digital assets 332 to generate a digital assets entitlement 530. As likewise described in greater detail herein, the digital assets entitlement 530 entitles a target system, which is associated with the original encrypted unique system identifier 528, to process the digital assets 332.

FIG. 6 is a simplified block diagram of a unique system identifier decrypted from an encrypted unique system identifier in accordance with an embodiment of the invention. It is not uncommon for system components to be replaced due to failure, erratic performance, becoming outmoded, or for other reasons. However, the replaced system component will typically have a different unique system component identifier. As a result, the entitlement association between a unique system identifier and predetermined digital assets may be compromised as a result of such a replacement, which in turn may prevent the target system from processing the digital assets.

In various embodiments, the unique system component identifier of the replacement system component is unknown until it is replaced in the target system. In these and other embodiments, the system component is replaced in the target system, the target system is then initiated (e.g., booted), and an inventory of unique system component identifiers is performed. In one embodiment, one or more unique system component identifiers, such as a serial number or service tag, are visible and may be visually inventoried. In another embodiment, one or more unique system component identifiers, such as a motherboard, processor, or hard drive serial number, are not visible and may be automatically inventoried.

As shown in FIG. 6, a new source unique system identifier 650 is generated from the inventoried unique system component identifiers. In one embodiment, a time stamp date and a time stamp time are components of the new source unique system identifier 650. In this embodiment, the time stamp date and a time stamp time are used to validate the authenticity of the new source unique system identifier 650. As an example, the provider of the replacement part may have stipulated that the replacement part be replaced on Nov. 12, 2009, between 8:00 AM and 6:00 PM. Accordingly, a time state date of Nov. 12, 2009 and a time stamp time of 16:33:42:05 would provide validation that the replacement part was replaced within the specified date and time interval.

An encryption operation 652 is then performed on the new source unique system identifier 650 to generate a new encrypted unique system identifier 628. As an example, the encryption operation may be performed using a private key associated with the target system and a public key associated with the provider of the replacement system component. The new encrypted unique system identifier 628 is then communicated to a digital asset entitlement system, which in turn performs a decryption operation 626 to generate a decrypted unique system identifier 622.

As likewise shown in FIG. 6, extract, transform, and load (ETL) and other database operations 634 are performed on the decrypted unique system identifier 622 to generate new unique system component identifiers 602. As shown in FIG. 6, the new unique system component identifiers now comprise a Model Number 304 ‘SA310J43, a Serial Number 306, ‘SEM5239923875’, a Factory ID 308 ‘AUS’, a Timestamp Date 610 ‘112009’, and a Timestamp Time 612 ‘16:33:42:05’. The new unique system component identifiers 602 likewise comprise a New Motherboard ID 314 ‘56812FR853945PL’, a Processor ID 316 ‘92348430-432919237’, a Hard Drive ID 318 ‘L83747HJ3672’, etc. In one embodiment, the Timestamp Date 610 and the Timestamp Time 612 are compared to previously authorized timestamp date and timestamp times to validate the authenticity of the new unique system component identifiers 602 and their corresponding decrypted unique system identifier 622. In this and other embodiments, if the decrypted unique system identifier 622 is validated, then a first set of operations are performed to remove the entitlement between the original encrypted unique system identifier and digital assets 332. A second set of operations are then performed to associate the new encrypted unique system identifier 628 with the digital assets 332 to generate a new entitlement 630. Accordingly, the integrity of the original entitlement between the original encrypted unique system identifier and the digital assets 332 is perpetuated by the new entitlement 630 between the new encrypted unique system identifier 628 and the digital assets 332.

In various other embodiments, the provider of the replacement system component is able to determine its associated unique system component identifier. In one embodiment, the unique system component identifier is known in advance. In another embodiment, the unique system component identifier may be one of a pool of, or a range of, possible unique system component identifiers set aside for replacement purposes. As described in greater detail herein, a new source unique identifier is generated, using the unique system component identifier of the component to be replaced. Once the new source unique identifier is generated the unique system component identifier of the replaced system component is invalidated. In these and other embodiments, the system component is replaced in the target system, the target system is then initiated (e.g., booted), and an inventory of unique system component identifiers is performed. In one embodiment, one or more unique system component identifiers, such as a serial number or service tag, are visible and may be visually inventoried. In another embodiment, one or more unique system component identifiers, such as a motherboard, processor, or hard drive serial number, are not visible and may be automatically inventoried.

As shown in FIG. 6, a new source unique system identifier 650 is generated from the inventoried unique system component identifiers. In one embodiment, a time stamp date and a time stamp time are components of the new source unique system identifier 650. In this embodiment, the time stamp date and a time stamp time are used to validate the authenticity of the new source unique system identifier 650. An encryption operation 652 is then performed on the new source unique system identifier 650 to generate a new encrypted unique system identifier 628. As an example, the encryption operation may be performed using a private key associated with the target system and a public key associated with the provider of the replacement system component. The new encrypted unique system identifier 628 is then communicated to a digital asset entitlement system, which in turn performs a decryption operation 626 to generate a decrypted unique system identifier 622.

Comparison operations 654 are then performed between the new source unique system identifier and the decrypted unique system identifier 622. If the comparison operations 654 are successful, then a first set of operations are performed to remove the entitlement between the original encrypted unique system identifier and digital assets 332. A second set of operations are then performed to associate the new encrypted unique system identifier 628 with the digital assets 332 to generate a new entitlement 630. Accordingly, the integrity of the original entitlement between the original encrypted unique system identifier and the digital assets 332 is perpetuated by the new entitlement 630 between the new encrypted unique system identifier 628 and the digital assets 332. Skilled practitioners of the art will recognize that many such embodiments are possible and the foregoing is not intended to limit the spirit, scope, or intent of the invention.

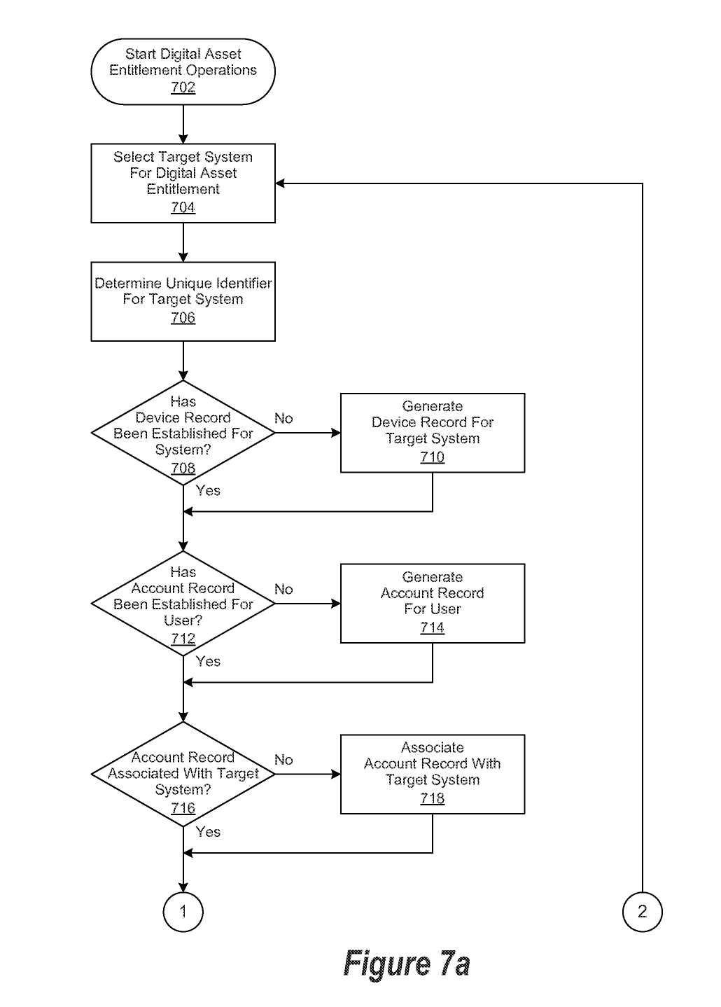

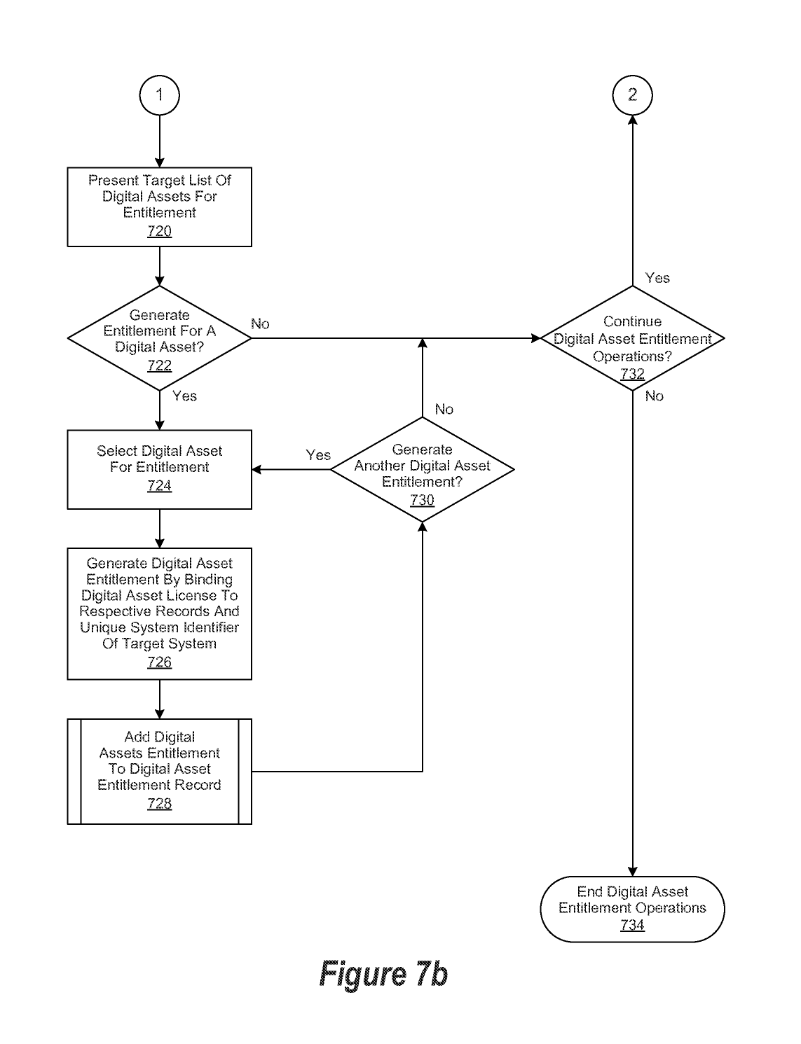

FIGS. 7a-b are a generalized flow chart of the performance of digital asset entitlement operations in an embodiment of the invention, In this embodiment, digital asset entitlement operations are started in step 702, followed by the selection of a target system in step 704 for digital assets entitlement. The unique system identifier of the target system, as described in greater detail herein, is determined in step 706, followed by a determination being made in step 708 whether a device record has been established for the target system. If not, then the device record is generated in step 710. As used herein, a device record refers to a data record containing data related to a system which will receive an entitlement to process associated digital assets. In various embodiments, the unique system identifier of the target system is stored in the device record. In various embodiments, other records may be associated with the device record to further describe the system, such as its model, type, make, internal identifiers, etc.

Once the device record has been generated, or if it is determined in step 708 that it has already been established, then a determination is made in step 712 whether an account record has been established for a user. If not, then the account record is generated for the user in step 714. As used herein, an account record refers to a data record containing data related to the association of multiple devices or systems to one or more entities. In various embodiments, the entity may be a single individual or a group of individuals. As an example, the entity may be a household with multiple PCs, a small business with several employees, a large corporation with many employees, etc. Other records may be attached to the account to further describe the account holder, payment information related to the account, etc. Accounts may further be broken down or organized into sub-accounts as needed, such as to describe departments within an enterprise). In various embodiments, a user may be associated with a single device or system or multiple devices or systems in the account record. Conversely, a group of users may be associated with a single device or system or multiple devices in the account record. Furthermore, groups of individual users may likewise be associated with groups of individual devices or systems. Those of skill in the art will recognize that many such associations are possible and the foregoing is not intended to limit the spirit, scope, or intent of the invention. Once the account record has been generated, or if it is determined in step 712 that it has already been established, then a determination is made in step 716 whether the account record is associated with the target system. If not, then the account record is associated with the target system in step 718.

Once the account record has been associated with the target system, or if it is determined in step 716 that it has already been associated, then a target list of digital assets is presented in step 720 for entitlement. A determination is then made in step 722 whether to generate an entitlement for a digital asset. If not, then a determination is made in step 732 whether to continue digital asset entitlement operations. If so, then the process is continued, proceeding with step 704. Otherwise digital asset entitlement operations are ended in step 734. However, if it is determined in step 722 to generate an entitlement for a digital asset, then a target digital asset is selected in step 724. A digital assets entitlement is then generated in step 726 by performing operations to associate the selected digital asset's corresponding license record with the aforementioned device record, account record, and other predetermined records. The resulting digital assets entitlement association is then added to the entitlement record in step 728. A determination is then made in step 730 whether to generate another digital assets entitlement. If so, the process is continued, proceeding with step 724. Otherwise, a determination is made in step 732 whether to continue digital asset entitlement operations. If so, then the process is continued, proceeding with step 704. Otherwise digital asset entitlement operations are ended in step 734.

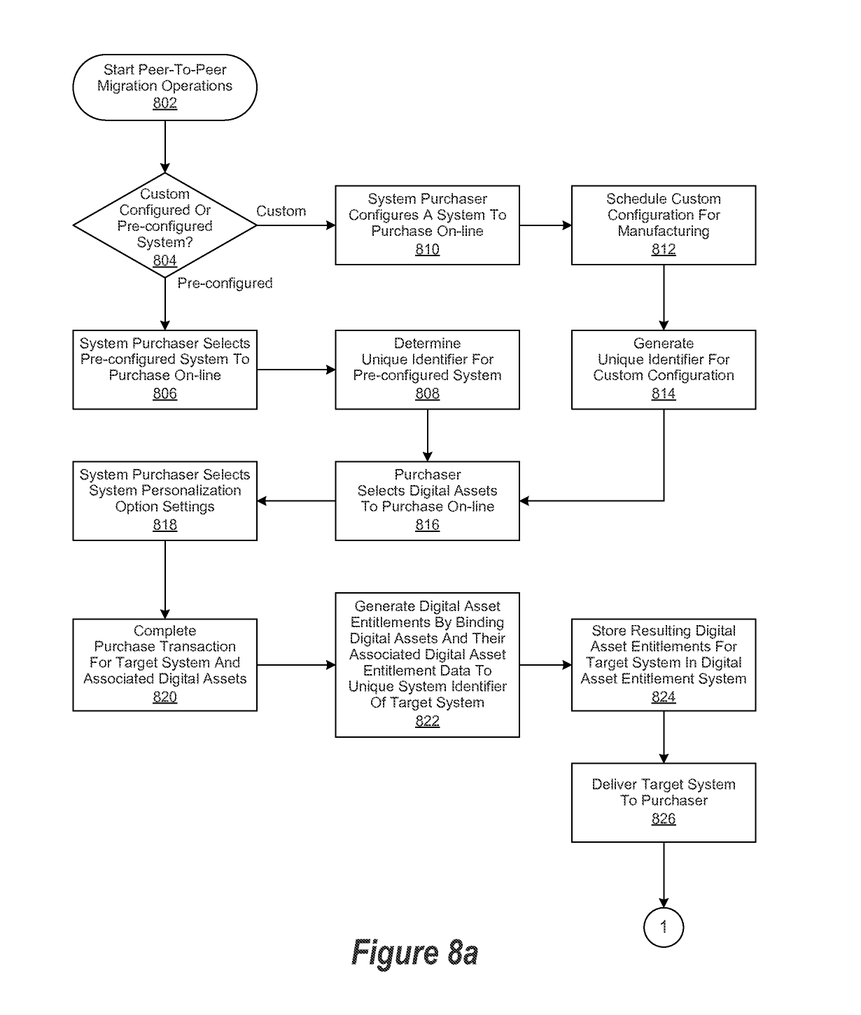

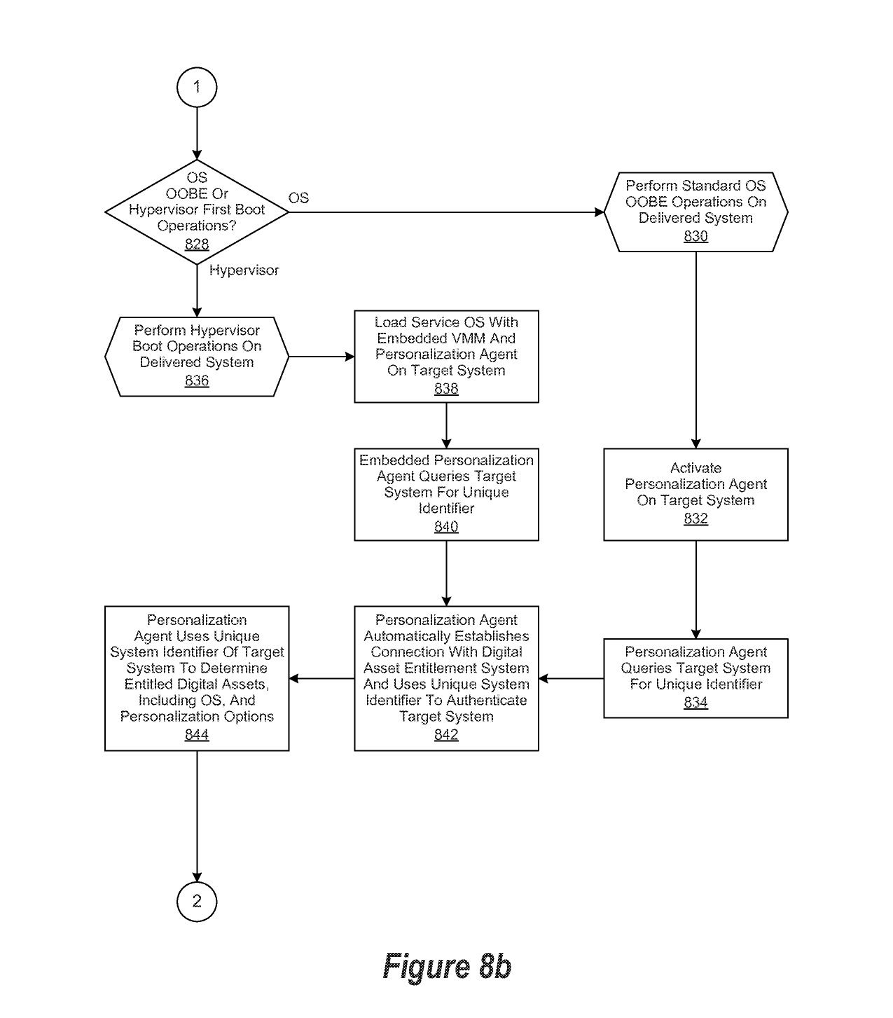

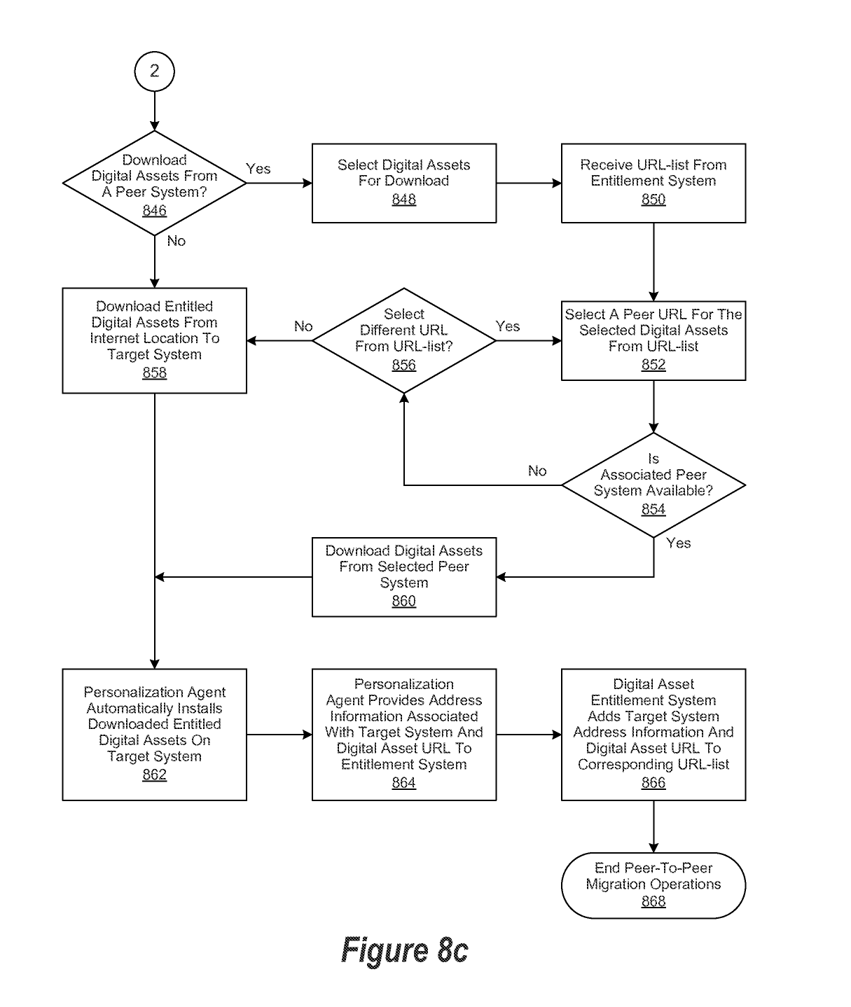

FIGS. 8a-b are a generalized flow chart of the performance of peer-to-peer (P2P) digital asset download operations in accordance with an embodiment of the invention. In this embodiment, P2P digital asset download operations are begun in step 802, followed by determining in step 804 whether a new system is to be a custom-configured system or a pre-configured system. If it is determined in step 804 that the new system is to be pre-configured, then the system purchaser selects the target system for on-line purchase in step 806. The unique identifier for the selected pre-configured system is then determined in step 808. In one embodiment, the unique system identifier is stored in the BIOS of the pre-configured system.

However, if it is determined in step 804 that the new system is to be a custom-configured system, then the system purchaser configures the system for on-line purchase in step 810. The system is then manufactured in step 812 according to the custom configuration selections made by the purchaser in step 810. Once manufactured, a unique system identifier is generated in step 814, as described in greater detail herein. Then, or after the unique system identifier is determined for the pre-configured system in step 808, the system purchaser selects digital assets for on-line purchase in step 816, followed by selecting personalization option settings for the custom-configured system in step 818.

A purchase transaction for the custom-configured or pre-configured target system and any associated digital assets and personalization options is completed in step 820. Digital asset entitlement operations, as described in greater detail herein, are then performed by a digital asset entitlement system in step 822 to bind the digital assets and their respective digital assets entitlement data to the unique system identifier of the target system. The resulting digital asset entitlements for the target system are then stored in the digital asset entitlement system in step 824, followed by the delivery of the custom-configured or pre-configured system to the system purchaser in step 826.

A determination is then made in step 828 whether to perform standard operating system (OS) out-of-the-box-experience (OOBE) or hypervisor first boot operations on the target system. If it is determined in step 828 to perform standard OS OOBE operations, then they are performed on the target system in step 830, followed by the activation of a previously-loaded personalization agent on the target system in step 832. The personalization agent then queries the target system for its unique system identifier in step 834. In various embodiments, the unique system identifier associated with the target system is stored in the target system's BIOS, flash memory, a hard disk, or other memory device.

However, if it is determined in step 828 to perform hypervisor (e.g., virtual machine monitor, or VMM) first boot operations on the target system, then they are performed in step 836. Then, in step 838, a service OS comprising an embedded virtual machine monitor (VMM) and an embedded personalization agent are loaded on the target system. The embedded personalization agent then queries the target system for its unique system identifier in step 840. Thereafter, or once the personalization agent queries the target system for its unique system identifier in step 834, the respective personalization agent automatically establishes a connection with the digital asset entitlement system in step 842 and uses the target system's unique system identifier to authenticate it to the digital asset entitlement system.

Then, in step 844, the unique system identifier is used by the personalization agent loaded on the target system to determine its entitled digital assets, which may include an OS and personalization options. A determination is then made in step 846 whether to download one or more entitled digital assets from a peer system. If so, the digital assets to be downloaded are selected in step 848, followed by the receipt of a URL-list containing the URLs of the selected digital assets in step 850. In one embodiment, the personalization agent on the target system requests the URL-list from the digital asset entitlement system, which then supplies it to the personalization agent.

A URL for each of the selected digital assets to be downloaded is then likewise selected from the URL-list in step 852, followed by a determination being made in step 854 whether the peer system corresponding to the selected URL is available. If not, then a determination is made in step 856 whether to select a different URL from the URL-list. If so, the process is continued, proceeding with step 852. If not, or if it was determined in step 846 not to download digital assets from a peer system, then the personalization agent on the target system automatically downloads the target system's entitled digital assets from their source location on the Internet to the target system in step 858.

However, if it was determined in step 854 that the peer system associated with the selected URL is available, then the selected digital assets are downloaded from the corresponding peer system in step 860. In one embodiment, the peer-to-peer download is performed by the personalization agents respectively installed on the peer systems. Thereafter, or once the entitled digital assets have been downloaded in step 858, the personalization agent installs them on the target system in step 862. Once the digital assets are installed on the target system, the personalization agent provides the target system's associated address information, and the URL of the installed digital asset, to the digital asset entitlement system in step 864. In turn, the digital asset entitlement system adds the address information associated with the target system, including the URL of the installed digital asset, to its corresponding URL-list in step 866. Peer-to-peer digital asset download operations are then ended in step 868.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for performing automated, peer-to-peer downloads of entitled digital assets, comprising:
receiving an identifier and a set of entitlement data, the identifier corresponding to a first system, the set of entitlement data corresponding to a digital asset;
processing the identifier and the set of entitlement data to generate a set of digital asset entitlements entitling the first system to use the digital asset;
processing the set of digital asset entitlements to generate an address list comprising a first set of address data corresponding to the location of the digital asset on a second system configured to provide the digital asset to the first system;
providing the address list to the first system;
receiving a second set of address data subsequent to the receipt of the digital asset from the second system, the second set of address data corresponding to the location of the digital asset on the first system; and
appending the second set of address data to the address list.

2. The method of claim 1, wherein the first system and the second system are peer systems connected to the same Internet Protocol (IP) sub-network.

3. The method of claim 1, wherein:
the first system uses the first set of address data to establish a peer-to-peer communications session with the second system; and
the first system receives the digital asset from the second system during the peer-to-peer communications session.

4. The method of claim 1, wherein:
the address list further comprises a third set of address data corresponding to the location of the digital asset on a third system configured to provide the digital asset to the first system;
the first system uses the third set of address data to establish a peer-to-peer communications session with the third system if the second system is unavailable; and
the first system receives the digital asset from the third system during the peer-to-peer communications session.

5. The method of claim 1, wherein the first system is subsequently configured to provide the digital asset to a fourth system entitled to use the digital asset.

6. The method of claim 1, wherein the second set of address data comprises at least one of the set of:
a Uniform Resource Locator (URL);
a host name associated with the first system;
an Internet Protocol (IP) address associated with the first system; and
a Media Access Control (MAC) address associated with the first system.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving an identifier and a set of entitlement data, the identifier corresponding to a first system, the set of entitlement data corresponding to a digital asset;
processing the identifier and the set of entitlement data to generate a set of digital asset entitlements entitling the first system to use the digital asset;
processing the set of digital asset entitlements to generate an address list comprising a first set of address data corresponding to the location of the digital asset on a second system configured to provide the digital asset to the first system;
providing the address list to the first system;
receiving a second set of address data subsequent to the receipt of the digital asset from the second system, the second set of address data corresponding to the location of the digital asset on the first system; and
appending the second set of address data to the address list.

8. The system of claim 7, wherein the first system and the second system are peer systems connected to the same Internet Protocol (IP) sub-network.

9. The system of claim 7, wherein:
the first system uses the first set of address data to establish a peer-to-peer communications session with the second system; and
the first system receives the digital asset from the second system during the peer-to-peer communications session.

10. The system of claim 7, wherein:
the address list further comprises a third set of address data corresponding to the location of the digital asset on a third system configured to provide the digital asset to the first system;
the first system uses the third set of address data to establish a peer-to-peer communications session with the third system if the second system is unavailable; and
the first system receives the digital asset from the third system during the peer-to-peer communications session.

11. The system of claim 7, wherein the first system is subsequently configured to provide the digital asset to a fourth system entitled to use the digital asset.

12. The system of claim 7, wherein the second set of address data comprises at least one of the set of:
a Uniform Resource Locator (URL);
a host name associated with the first system;
an Internet Protocol (IP) address associated with the first system; and
a Media Access Control (MAC) address associated with the first system.

13. A non-transitory, computer-readable storage medium embodying computer program code, the computer program code comprising computer executable instructions configured for:
receiving an identifier and a set of entitlement data, the identifier corresponding to a first system, the set of entitlement data corresponding to a digital asset;
processing the identifier and the set of entitlement data to generate a set of digital asset entitlements entitling the first system to use the digital asset;
processing the set of digital asset entitlements to generate an address list comprising a first set of address data corresponding to the location of the digital asset on a second system configured to provide the digital asset to the first system;
providing the address list to the first system;
receiving a second set of address data subsequent to the receipt of the digital asset from the second system, the second set of address data corresponding to the location of the digital asset on the first system; and
appending the second set of address data to the address list.

14. The non-transitory, computer-readable storage medium of claim 13, wherein the first system and the second system are peer systems connected to the same Internet Protocol (IP) sub-network.

15. The non-transitory, computer-readable storage medium of claim 13, wherein:
the first system uses the first set of address data to establish a peer-to-peer communications session with the second system; and
the first system receives the digital asset from the second system during the peer-to-peer communications session.

16. The non-transitory, computer-readable storage medium of claim 13, wherein:
the address list further comprises a third set of address data corresponding to the location of the digital asset on a third system configured to provide the digital asset to the first system;
the first system uses the third set of address data to establish a peer-to-peer communications session with the third system if the second system is unavailable; and
the first system receives the digital asset from the third system during the peer-to-peer communications session.

17. The non-transitory, computer-readable storage medium of claim 13, wherein the first system is subsequently configured to provide the digital asset to a fourth system entitled to use the digital asset.

18. The non-transitory, computer-readable storage medium of claim 13, wherein the second set of address data comprises at least one of the set of:
a Uniform Resource Locator (URL);
a host name associated with the first system;
an Internet Protocol (IP) address associated with the first system; and
a Media Access Control (MAC) address associated with the first system.
